(19) United States
(12) Patent Application Publication
(10) Pub. No.: US 2026/0292171 A1
(43) Pub. Date: Sep. 24, 2026

(54) METHODS AND APPARATUS OF GEOMETRY PARTITION MODE WITH SUBBLOCK MODES

(71) Applicant: MEDIATEK INC., Hsinchu City (TW)

(72) Inventors: Chih-Hsuan LO, Hsinchu City (TW); Tzu-Der CHUANG, Hsinchu City (TW); Ching-Yeh CHEN, Hsinchu City (TW); Chih-Wei HSU, Hsinchu City (TW); Yi-Wen CHEN, San Jose, CA (US)

(21) Appl. No.: 19/473,114

(22) PCT Filed: Sep. 10, 2024
(86) PCT No.: PCT/CN2024/117963

§ 371 Date: Oct. 6, 2025

Related U.S. Application Data
(60) Provisional application No. 63/590,005, filed on Oct. 13, 2023.
(60) Provisional application No. 63/590,480, filed on Oct. 16, 2023.

(51) Int. Cl. H04N 19/119; H04N 19/105; H04N 19/109; H04N 19/11; H04N 19/139; H04N 19/176; H04N 19/70

(52) U.S. Cl. CPC H04N 19/119; H04N 19/105; H04N 19/109; H04N 19/11; H04N 19/139; H04N 19/176; H04N 19/70

(57) ABSTRACT

A method and apparatus for video coding are disclosed. According to the method, the current block is partitioned into a first region and a second region along a partition line. A target candidate list comprising one or more GPM (Geometry Partition Mode) subblock candidates corresponding to one or more GPM subblock modes for one of the first region and the second region is derived. Said one of the first region and the second region are encoded or decoded using the target candidate list comprising said one or more GPM subblock candidates. According to another method, an inherited LIC (Local Illumination Compensation) flag is determined by inheriting a reference LIC flag associated with a reference block of the current block.

### CROSS REFERENCE TO RELATED APPLICATIONS

The present invention is a non-Provisional application of and claims priority to U.S. Provisional Patent Application No. 63/590,005, filed on Oct. 13, 2023 and U.S. Provisional Patent Application No. 63/590,480, filed on Oct. 16, 2023. The U.S. Provisional patent applications are hereby incorporated by reference in their entireties.

### TECHNICAL FIELD

The present invention relates to video coding system. In particular, the present invention relates to using subblock candidate list for at least one partition generated by GPM (Geometric Partition Mode) in a video coding system. Also, the use of inherited LIC (Local Illumination Compensation) for GPM is disclosed.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### Inter Prediction Overview

According to JVET-T2002 Section 3.4. (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)), for each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU, which are obtained from neighbouring CUs, including spatial and temporal candidates, and additional schedules introduced in VVC. The merge mode can be applied to any inter-predicted CU, not only for skip mode. The alternative to the merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following description provides the details of those inter prediction methods specified in VVC.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set (SPS) header and the maximum allowed size of merge list is 6. For each CU coded in the merge mode, an index of best merge candidate is encoded using truncated unary binarization (TU). The first bin of the merge index is coded with context and bypass coding is used for remaining bins.

The derivation process of each category of the merge candidates is provided in this session. As done in HEVC, VVC also supports parallel derivation of the merge candidate lists (or called as merging candidate lists) for all CUs within a certain size of area.

### Affine Motion Compensated Prediction

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. As shown FIGS. 2A-B, the affine motion field of the block 210 is described by motion information of two control point (4-parameter) in FIG. 2A or three control point motion vectors (6-parameter) in FIG. 2B.

For 4-parameter affine motion model, motion vector at sample location (x,y) in a block is derived as:

$$\{ \begin{matrix}m {v}_{x} = \frac{m {v}_{1 x} - m {v}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} \qquad ( 1 )$$

For 6-parameter affine motion model, motion vector at sample location (x,y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 2 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

In order to simplify the motion compensation prediction, block based affine transform prediction is applied. To derive motion vector of each 4×4 luma subblock, the motion vector of the centre sample of each subblock, as shown in FIG. 3, is calculated according to above equations, and rounded to 1/16 fraction accuracy. Then, the motion compensation interpolation filters are applied to generate the prediction of each subblock with the derived motion vector. The subblock size of chroma-components is also set to be 4×4. The MV of a 4×4 chroma subblock is calculated as the average of the MVs of the top-left and bottom-right luma subblocks in the collocated 8×8 luma region.

As is for translational-motion inter prediction, there are also two affine motion inter prediction modes: affine merge mode and affine AMVP mode.

### Affine Merge Prediction

AF_MERGE mode can be applied for CUs with both width and height larger than or equal to 8. In this mode, the CPMVs (Control Point MVs) of the current CU is generated based on the motion information of the spatial neighbouring CUs. There can be up to five CPMVP (CPMV Prediction) candidates and an index is signalled to indicate the one to be used for the current CU. The following three types of CPVM candidate are used to form the affine merge candidate list:
Inherited affine merge candidates that are extrapolated from the CPMVs of the neighbour CUs
Constructed affine merge candidates CPMVPs that are derived using the translational MVs of the neighbour CUs
Zero MVs

In VVC, there are two inherited affine candidates at most, which are derived from the affine motion model of the neighbouring blocks, one from left neighbouring CUs and one from above neighbouring CUs. The candidate blocks are the same as those shown in FIG. 4. For the left predictor, the scan order is A₀->A₁, and for the above predictor, the scan order is B0->B₁->B₂. Only the first inherited candidate from each side is selected. No pruning check is performed between two inherited candidates. When a neighbouring affine CU is identified, its control point motion vectors are used to derived the CPMVP candidate in the affine merge list of the current CU. As shown in FIG. 5, if the neighbouring left bottom block A of the current block 510 is coded in affine mode, the motion vectors v₂, v₃ and v₄ of the top left corner, above right corner and left bottom corner of the CU 520 containing block A are attained. When block A is coded with 4-parameter affine model, the two CPMVs of the current CU (i.e., v₀ and v₁) are calculated according to v₂, and v₃. In case that block A is coded with 6-parameter affine model, the three CPMVs of the current CU are calculated according to v₂, v₃ and v₄.

Constructed affine candidate means the candidate is constructed by combining the neighbouring translational motion information of each control point. The motion information for the control points is derived from the specified spatial neighbours and temporal neighbours for a current block 610 as shown in FIG. 6. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. For TMVP is used as CPMV₄ if it's available.

After MVs of four control points are attained, affine merge candidates are constructed based on the motion information. The following combinations of control point MVs are used to construct in order:

$$\{ {CPMV}_{1} , {CPMV}_{2} , {CPMV}_{3} \} , \{ {CPMV}_{1} , {CPMV}_{2} , {CPMV}_{4} \} , \\ \{ {CPMV}_{1} , {CPMV}_{3} , {CPMV}_{4} \} , \{ {CPMV}_{2} , {CPMV}_{3} , {CPMV}_{4} \} , \\ \{ {CPMV}_{1} , {CPMV}_{2} \} , \{ {CPMV}_{1} , {CPMV}_{3} \}$$

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### Affine AMVP Prediction

Affine AMVP mode can be applied for CUs with both width and height larger than or equal to 16. An affine flag in the CU level is signalled in the bitstream to indicate whether affine AMVP mode is used and then another flag is signalled to indicate whether 4-parameter affine or 6-parameter affine is used. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighbouring CUs
Zero MVs

The checking order of inherited affine AMVP candidates is the same as the checking order of inherited affine merge candidates. The only difference is that, for AVMP candidate, only the affine CU that has the same reference picture as current block is considered. No pruning process is applied when inserting an inherited affine motion predictor into the candidate list.

Constructed AMVP candidate is derived from the specified spatial neighbours shown in FIG. 6. The same checking order is used as that in the affine merge candidate construction. In addition, the reference picture index of the neighbouring block is also checked. In the checking order, the first block that is inter coded and has the same reference picture as in current CUs is used. When the current CU is coded with the 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, the constructed AMVP candidate is set as unavailable.

If the number of affine AMVP list candidates is still less than 2 after valid inherited affine AMVP candidates and constructed AMVP candidate are inserted, mv₀, mv₁ and mv₂ will be added as the translational MVs in order to predict all control point MVs of the current CU, when available. Finally, zero MVs are used to fill the affine AMVP list if it is still not full.

### Affine Motion Information Storage

In VVC, the CPMVs of affine CUs are stored in a separate buffer. The stored CPMVs are only used to generate the inherited CPMVPs in the affine merge mode and affine AMVP mode for the lately coded CUs. The subblock MVs derived from CPMVs are used for motion compensation, MV derivation of merge/AMVP list of translational MVs and de-blocking.

To avoid the picture line buffer for the additional CPMVs, affine motion data inheritance from the CUs of the above CTU is treated differently for the inheritance from the normal neighbouring CUs. If the candidate CU for affine motion data inheritance is in the above CTU line, the bottom-left and bottom-right subblock MVs in the line buffer instead of the CPMVs are used for the affine MVP derivation. In this way, the CPMVs are only stored in a local buffer. If the candidate CU is 6-parameter affine coded, the affine model is degraded to 4-parameter model. As shown in FIG. 7, along the top CTU boundary, the bottom-left and bottom right subblock motion vectors of a CU are used for affine inheritance of the CUs in bottom CTUs. In FIG. 7, line 710 and line 712 indicate the x and y coordinates of the picture with the origin (0,0) at the upper left corner. Legend 720 shows the meaning of various motion vectors, where arrow 722 represents the CPMVs for affine inheritance in the local buff, arrow 724 represents sub-block vectors for MC/merge/skip/AMVP/deblocking/TMVPs in the local buffer and for affine inheritance in the line buffer, and arrow 726 represents sub-block vectors for MC/merge/skip/AMVP/deblocking/TMVPs.

Prediction Refinement with Optical Flow (PROF) for Affine Mode

Subblock based affine motion compensation can save memory access bandwidth and reduce computation complexity compared to pixel based motion compensation, at the cost of prediction accuracy penalty. To achieve a finer granularity of motion compensation, Prediction Refinement with Optical Flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps:

Step 1) The subblock-based affine motion compensation is performed to generate subblock prediction I(i,j).

Step2) The spatial gradients gₓ(i,j) and g_{y}(i,j) of the subblock prediction are calculated at each sample location using a 3-tap filter [−1, 0, 1]. The gradient calculation is exactly the same as gradient calculation in BDOF (Bi-Directional Optical Flow):

$${g}_{x} ( i , j ) = ( I ( i + 1 , j ) ≫ shift 1 ) - ( I ( i - 1 , j ) ≫ shift 1 ) ,$$

$${g}_{y} ( i , j ) = ( I ( i , j + 1 ) ≫ shift 1 ) - ( I ( i , j - 1 ) ≫ shift 1 ) .$$

In the above equations, shift1 is used to control the gradient's precision. The subblock (i.e. 4×4) prediction is extended by one sample on each side for the gradient calculation. To avoid additional memory bandwidth and additional interpolation computation, those extended samples on the extended borders are copied from the nearest integer pixel position in the reference picture.

Step 3) The luma prediction refinement is calculated by the following optical flow equation:

$$Δ I ( i , j ) = {g}_{x} ( i , j ) * Δ {v}_{x} ( i , j ) + {g}_{y} ( i , j ) * Δ {v}_{y} ( i , j ) . \qquad ( 3 )$$

where the Δv(i,j) is the difference between sample MV computed for sample location (i,j), denoted by v(i,j), and the subblock MV of the subblock to which sample (i,j) belongs, as shown in FIG. 8. The Δv(i,j) is quantized in the unit of 1/32 luam sample precision. In FIG. 8, sub-block 822 corresponds to a reference sub-block for sub-block 820 as pointed by the motion vector v_{SB} (812). The reference sub-block 822 represents a reference sub-block resulted from translational motion of block 820. Reference sub-block 824 corresponds to a reference sub-block processed with PROF. The motion vector for each pixel is refined by Δv(i,j). For example, the refined motion vector v(i,j) 814 for the top-left pixel of the sub-block 820 is derived based on the sub-block MV v_{SB} (812) modified by Δv(i,j) 816.

Since the affine model parameters and the sample location relative to the subblock centre are not changed from subblock to subblock, Δv(i,j) can be calculated for the first subblock, and reused for other subblocks in the same CU. Let dx(i,j) and dy(i,j) be the horizontal and vertical offset from the sample location (i,j) to the center of the subblock (x_{SB}, y_{SB}), Δv(x,y) can be derived by the following equation:

$$\{ \begin{matrix}dx ( i , j ) = i - {x}_{S B} \\ dy ( i , j ) = j - {y}_{SB}\end{matrix} ,$$

$$\{ \begin{matrix}Δ {v}_{x} ( i , j ) = C * d x ( i , j ) + D * d y ( i , j ) \\ Δ {v}_{y} ( i , j ) = E * d x ( i , j ) + F * d y ( i , j )\end{matrix} .$$

In order to keep accuracy, the enter of the subblock (x_{SB},y_{SB}) is calculated as ((W_{SB}−1)/2, (H_{SB}−1)/2), where W_{SB} and H_{SB} are the subblock width and height, respectively.

For 4-parameter affine model,

$$\{ \begin{matrix}C = F = \frac{{v}_{1 x} - {v}_{0 x}}{w} \\ E = - D = \frac{{v}_{1 y} - {v}_{0 y}}{w}\end{matrix}$$

For 6-parameter affine model,

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix}$$

where (v₀ₓ, v_{0y}), (v₁ₓ, v_{1y}), (v₂ₓ, v_{2y}) are the top-left, top-right and bottom-left control point motion vectors, w and h are the width and height of the CU.

Step 4) Finally, the luma prediction refinement ΔI(i,j) is added to the subblock prediction I(i,j). The final prediction I′ is generated as the following equation.

$${I}^{′} ( i , j ) = I ( i , j ) + Δ I ( i , j )$$

PROF is not applied in two cases for an affine coded CU: 1) all control point MVs are the same, which indicates the CU only has translational motion; 2) the affine motion parameters are greater than a specified limit because the subblock based affine MC (Motion Compensation) is degraded to CU based MC to avoid large memory access bandwidth requirement.

A fast encoding method is applied to reduce the encoding complexity of affine motion estimation with PROF. PROF is not applied at affine motion estimation stage in following two situations: a) if this CU is not the root block and its parent block does not select the affine mode as its best mode, PROF is not applied since the possibility for current CU to select the affine mode as best mode is low; b) if the magnitude of four affine parameters (C, D, E, F) are all smaller than a predefined threshold and the current picture is not a low delay picture, PROF is not applied because the improvement introduced by PROF is small for this case. In this way, the affine motion estimation with PROF can be accelerated.

### Sample-Based BDOF

In the sample-based BDOF, instead of deriving motion refinement (Vx, Vy) on a block basis, it is performed per sample.

The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive Vx and Vy. The derived motion refinement (Vx, Vy) is applied to adjust the bi-predicted sample value for the centre sample of the window.

### Affine Subblock BDOF Refinement

In JVET-AE0148 (Zhi Zhang, et al., “Non-EE2: Affine subblock BDOF refinement”, 31st Meeting, Geneva, CH, 11-19 Jul. 2023, Document: JVET-AE0148), it is proposed to apply BDOF subblock MV refinement and sample adjustment to an affine coded block when the block meets the BDOF condition and the block is determined to use subblock MC (e.g., OBMC being applied to subblocks). It also proposes to apply BDOF to SbTMVP coded block, when the entire or a sub-area of the block meets the BDOF condition.

An affine coded block derives MVs for each 4×4 subblock from the affine model. The BDOF process starts with the 4×4 subblock grouping with identical MVs. When the grouped subblock size is less than 256, BDOF MV refinement is processed in 4×4 subblock grid, and otherwise in 8×8 subblock grid.

The BDOF enabling condition is same as ECM-9.0, e.g., two reference pictures have equal POC distance to the current picture, and equal weight prediction.

### Template Matching Based OBMC

In template matching based OBMC scheme, instead of directly using the weighted prediction, the prediction value of CU boundary samples derivation approach is decided according to the template matching costs, including using current block's motion information only, or using neighbouring block's motion information as well with one of the blending modes.

In this scheme for each block with a size of 4×4 at the top CU boundary, the above template size equals to 4×1. If N adjacent blocks have the same motion information, then the above template size is enlarged to 4N×1 since the MC operation can be processed at one time. For each left block with a size of 4×4 at the left CU boundary, the left template size equals to 1×4 or 1×4N as shown in FIG. 9.

For each 4×4 top block (or N 4×4 blocks group), the prediction value of boundary samples is derived according to the following steps:
Take block A as the current block and its above neighbouring block AboveNeighbour_A for example. The operation for left blocks is conducted in the same manner.
First, three template matching costs (Cost1, Cost2, Cost3) are measured by SAD between the reconstructed samples of a template and its corresponding reference samples derived by MC process according to the following three types of motion information:
   i. Cost1 is calculated according to A's motion information.
   ii. Cost2 is calculated according to AboveNeighbour_A's motion information.
   iii. Cost3 is calculated according to weighted prediction of A's and AboveNeighbour_A's motion information with weighting factors as ¾ and ¼ respectively.
Second, choose one out of three approaches to calculate the final prediction results of boundary samples by comparing Cost1, Cost2 and Cost 3.

The original MC result using current block's motion information is denoted as Pixel1, and the MC result using neighbouring block's motion information is denoted as Pixel2.

The final prediction result is denoted as NewPixel.
If Cost1 is minimum, then NewPixel(i,j)=Pixel1(i,j).
If (Cost2+(Cost2>>2)+(Cost2>>3))<=Cost1, then blending mode 1 is used.
   For luma blocks, the number of blending pixel rows is 4.

$$NewPixel ( i , 0 ) = ( 26 \times P ixel 1 ( i , 0 ) + 6 \times P i x e l 2 ( i , 0 ) + 16 ) ≫ 5 \\ NewPixel ( i , 1 ) = ( 7 \times P i x e l 1 ( i , 1 ) + P i x e l 2 ( i , 1 ) + 4 ) ≫ 3 \\ NewPixel ( i , 2 ) = ( 15 \times P i x e l 1 ( i , 2 ) + P i x e l 2 ( i , 2 ) + 8 ) ≫ 4 \\ NewPixel ( i , 3 ) = ( 31 \times P i x e l 1 ( i , 3 ) + P i x e l 2 ( i , 3 ) + 16 ) ≫ 5$$

For chroma blocks, the number of blending pixel rows is 1.

$$NewPixel ( i , 0 ) = ( 26 \times P ixel 1 ( i , 0 ) + 6 \times Pixel2 ( i , 0 ) + 16 ) ≫ 5$$

If Cost1<=Cost2, then blending mode 2 is used.
   For luma blocks, the number of blending pixel rows is 2.

$$NewPixel ( i , 0 ) = ( 15 \times P i x e l 1 ( i , 0 ) + P i x e l 2 ( i , 0 ) + 8 ) ≫ 4 \\ NewPixel ( i , 1 ) = ( 31 \times P i x e l 1 ( i , 1 ) + P i x e l 2 ( i , 1 ) + 16 ) ≫ 5$$

For chroma blocks, the number of blending pixel rows is 1.

$$NewPixel ( i , 0 ) = ( 15 \times P ixel 1 ( i , 0 ) + P i x e l 2 ( i , 0 ) + 8 ) ≫ 4$$

Otherwise, blending mode pb 3 is used.
   For luma blocks, the number of blending pixel rows is 4.

$$N e w P i x e l ( i , 1 ) = ( 7 \times P i x e l 1 ( i , 1 ) + P i x e l 2 ( i , 1 ) + 4 ) ≫ 3 \\ NewPixel ( i , 2 ) = ( 15 \times P i x e l 1 ( i , 2 ) + P i x e l 2 ( i , 2 ) + 8 ) ≫ 4 \\ NewPixel ( i , 3 ) = ( 31 \times P i x e l 1 ( i , 3 ) + P i x e l 2 ( i , 3 ) + 16 ) ≫ 5$$

For chroma blocks, the number of blending pixel rows is 1.

$$NewPixel ( i , 0 ) = ( 7 \times P ixel 1 ( i , 0 ) + P i x e l 2 ( i , 0 ) + 4 ) ≫ 3$$

### History-Parameter-Based Affine Model Inheritance and Non-Adjacent Affine Mode

History-parameter-based affine model inheritance (HAMI) allows the affine model to be inherited from a previously affine-coded block, which may not be neighbouring to the current block. Similar to the enhanced regular merge mode, non-adjacent affine mode (NA-AFF) is introduced.

A first history-parameter table (HPT) is established. An entry of the first HPT stores a set of affine parameters: a, b, c and d, each of which is represented by a 16-bit signed integer. Entries in HPT are categorized by reference list and reference index. Five reference indices are supported for each reference list in HPT. The category of HPT (denoted as HPTCat) is calculated as:

$$HPTCat ( RefList , RefIdx ) = 5 \times RefList + min ( RefIdx , 4 ) ,$$

wherein RefList and RefIdx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefList_{cur} and reference index RefIdx_{cur}, the affine parameters are utilized to update entries in the category HPTCat(RefList_{cur}, RefIdx_{cur}) in a way similar to HMVP table updating.

A history-affine-parameter-based candidate (HAPC) is derived from one of the seven neighbouring 4×4 blocks denoted as AG, A1, A2, B0, B1, B2 or B3 in FIG. 6 and a set of affine parameters stored in a corresponding entry in the first HPT. The MV of a neighbouring 4×4 block serves as the base MV. The MV of the current block at position (x,y) is calculated as:

$$\{ \begin{matrix}m {v}^{h} ( x , y ) = a ( x - {x}_{b a s e} ) + c ( y - {y}_{b a s e} ) + m {v}_{b a s e}^{h} \\ m {v}^{v} ( x , y ) = b ( x - {x}_{b a s e} ) + d ( y - {y}_{b a s e} ) + m {v}_{b a s e}^{v}\end{matrix} ,$$

where (mv^{h}_{base}, mv^{v}_{base}) represents the MV of the neighbouring 4×4 block, (x_{base}, y_{base}) represents the centre position of the neighbouring 4×4 block. (x,y) can be the top-left, top-right and bottom-left corner of the current block to obtain the corner-position MVs (CPMVs) for the current block, or it can be the centre of the current block to obtain a regular MV for the current block.

A second history-parameter table (HPT) with base MV information is also appended. There are nine entries in the second HPT, wherein an entry comprises a base MV, a reference index and four affine parameters for each reference list, and a base position. An additional merge HAPC can be generated from the second HPT with the base MV information the corresponding affine models stored in an entry. The difference between the first HPT (FIG. 10A) and the second HPT (FIG. 10B) is illustrated in FIG. 10.

Moreover, pair-wised affine merge candidates are generated by two affine merge candidates, which are history-derived or non-history-derived. A pair-wised affine merge candidate is generated by averaging the CPMVs of existing affine merge candidates in the list.

As a response to new HAPCs being introduced, the size of sub-block-based merge candidate list is increased from five to fifteen, which are all involved in the ARMC process.

In NA-AFF, the pattern of obtaining non-adjacent spatial neighbours is shown in FIG. 11. Same as the existing non-adjacent regular merge candidates, the distances between non-adjacent spatial neighbours and current coding block in the NA-AFF are also defined based on the width and height of current CU.

The motion information of the non-adjacent spatial neighbours in FIGS. 11A-B is utilized to generate additional inherited and/or constructed affine merge candidates for the current CU (e.g. block 1110 in FIG. 11A and block 1120 in FIG. 11B). Specifically, for inherited candidates, the same derivation process of the inherited affine merge candidates in the VVC is kept unchanged except that the CPMVs are inherited from non-adjacent spatial neighbours. In other words, the CPMVs may correspond to inherited MVs based on one or more non-adjacent neighbouring MVs in one example or constructed MVs derived from one or more non-adjacent neighbouring MVs in another example. In yet another example, the CPMVs may correspond to inherited MVs based on one or more non-adjacent neighbouring MVs or constructed MVs derived from one or more non-adjacent neighbouring MVs. The non-adjacent spatial neighbours are checked based on their distances to the current block from near neighbours to far neighbours. At a specific distance, only the first available neighbour (i.e., one coded with the affine mode) from each side (e.g., the left and above) of the current block is included for inherited candidate derivation. As indicated by the dash arrows in FIG. 11A, the checking orders of the neighbours on the left and above sides are bottom-to-up and right-to-left, respectively. For constructed candidates (namely “the first type of constructed affine candidates from non-adjacent neighbours”), as shown in the FIG. 11B, the positions of one left and one above non-adjacent spatial neighbours are firstly determined independently. After that, the location of the top-left neighbour can be determined accordingly which can enclose a rectangular virtual block together with the left and above non-adjacent neighbours. Then, as shown in the FIG. 12, the motion information of the three non-adjacent neighbours at locations A, B and C is used to form the CPMVs at the top-left (A), top-right (B) and bottom-left (C) of the virtual block, which is finally projected to the current CU to generate the corresponding constructed candidates.

For the first type of constructed candidates, as shown in the FIG. 11A, the positions of one left and above non-adjacent spatial neighbours are firstly determined independently; After that, the location of the top-left neighbour can be determined accordingly which can enclose a rectangular virtual block together with the left and above non-adjacent neighbours. Then, as shown in the FIG. 12, the motion information of the three non-adjacent neighbours is used to form the CPMVs at the top-left (A), top-right (B) and bottom-left (C) of the virtual block, which is finally projected to the current CU to generate the corresponding constructed candidates.

The NA-AFF candidates are inserted into the existing affine merge candidate list and affine AMVP candidate list according to the following orders:

### Affine Merge Mode:

1. SbTMVP candidate, if available
2. Inherited from adjacent neighbours
3. Inherited from non-adjacent neighbours
4. Constructed from adjacent neighbours
5. The first type of constructed affine candidates from non-adjacent neighbours
6. Zero MVs

### Affine AMVP Mode:

1. Inherited from adjacent neighbours
2. Constructed from adjacent neighbours
3. Translational MVs from adjacent neighbours
4. Translational MVs from temporal neighbours
5. Inherited from non-adjacent neighbours
6. The first type of constructed affine candidates from non-adjacent neighbours
7. Zero MVs

Due to the inclusion of the additional candidates generated by NA-AFF, the size of the affine merge candidate list is increased from 5 to 15. The subgroup size of ARMC for the affine merge mode is increased from 3 to 15.

In NA-AFF:
1. The area from where the non-adjacent neighbours come is restricted to be within the current CTU (i.e., no additional storage requirements for line buffer).
2. The storage granularity for affine motion information, including CPMVs and reference indexes, is reduced from 8×8 to 16×16 (i.e., only the affine motion from the top-left 8×8 block is saved). Additionally, the saved CPMVs are projected to each 16×16 block before storage, such that the position and size information are not needed.
3. Only the top-left and top-right CPMVs are stored (i.e., always using 4-parameter affine model for NA-AFF).

### Regression Based Affine Candidate Derivation

The Regression based Motion Vector Field (RMVF) derivation method provides a new variety of subblock-based merge candidate. The motion vectors and centre positions from the neighbouring subblocks of the current CU, as illustrated in FIG. 13, are used as the input to the linear regression process to derive a set of linear model parameters.

The subblock motion field from a previous coded affine CU and the motion vectors from the adjacent subblocks of the current CU are used as the input for the regression process. The predicted CPMVs for the current block are derived as output.

The regression based affine merge candidates are derived and added to the affine merge list. Subblock motion field from a previously coded affine CU and motion information from adjacent subblocks of a current CU are used as the input to the regression process to derive proposed affine candidates.

The previously coded affine CU can be identified from scanning through non-adjacent positions and the affine HMVP table.

Adjacent subblock information of current CU is fetched from 4×4 sub-blocks represented by the grey zone as depicted in FIG. 13. For each sub-block, given a reference list, the corresponding motion vector and centre coordinate of the sub-block may be used.

For each affine CU, up to 2 affine candidates can be derived. One with adjacent subblock information and one without. All the linear-regression-generated candidates are pruned and collected into one candidate sub-group, and TM cost based ARMC process is applied when ARMC is enabled. Afterwards, up to N linear-regression-generated candidates are added to the affine merge list when N affine CUs are found. The number of affine candidates for ARMC is 30, the output list size is 15.

### DMVR for Affine Merge Coded Blocks

DMVR is applied to affine merge coded blocks and affine MMVD coded blocks when DMVR condition is satisfied. It is also extended to adaptive BM merge mode.

An affine motion field is modelled as follows (6-parameters affine case):

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix}$$

wherein(mvₓ, mv_{y}) is the motion vector at location (x,y) and (mv₀ₓ, mv_{0y}) is the base MV representing the translation motion of the affine model. Parameters (mv₁ₓ−mv₀ₓ/W, (mv₂ₓ−mv₀ₓ)/H, (mv_{1y}−mv_{0y})/W and (mv_{2y}−mv_{0y})/H represent the non-translation parameters (rotation, scaling).

Motion vectors (mv₀ₓ, mv_{0y}), (mv₁ₓ, mv_{1y}) and (mv₂ₓ, mv_{2y}) are called the control point motion vectors (CPMVs) of the considered affine coding unit. In the DMVR process applied to affine, the bilateral matching cost is calculated per subblock. Then, the subblock bilateral matching costs and refined subblock MVs are used to determine the overall best refined CPMVs for the affine block. More specific, the CPMVs are refined according to the following steps:
1) Perform integer-pel bilateral matching for subblocks. Accumulate the subblock bilateral matching cost to determine the best integer-pel MV offset.
2) Perform half-pel bilateral matching search using the best integer MV offset as initial offset and output the best MV offset that minimizes the bilateral matching cost for the same set of the subblocks of step 1.
3) Perform linear regression using the refined subblock MVs from step 1 as input and output a set of control-point motion vectors.
4) Compare the bilateral matching cost of the output of the steps 2 and 3 to select the one with the smallest cost.

In addition, the non-translation parameters of affine model are refined after the base MV are determined. Each of CPMVs is fixed as base MV in turn, and an offset is added to the non-translation parameter of affine model by minimizing the bilateral matching cost, and then the other two CPMVs are calculated according to based MV and refined non-translation parameters.

For affine merge and affine MMVD modes, both CPMVs and non-translation parameters refinements are applied. When applying to affine MMVD mode, the MMVD offset is added to the affine DMVR refined affine merge base candidate if the base candidate meets the affine DMVR refinement condition. For adaptive BM merge mode, an affine merge list containing only affine merge candidates that meet the affine DMVR conditions are constructed and then CPMVs refinement and non-translation parameters refinement are applied.

### Pixel Based Affine Motion Compensation

The minimum affine subblock size is changed from 4×4 to 1×1 for both luma and chroma components, 1×1 subblock size allows pixel based affine MC. When affine subblock width or height is smaller than 4, PROF is disabled.

### Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

When this mode is used, a CU is split into two parts by a geometrically located straight line as shown in FIG. 14. The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in Section “Uni-prediction Candidate List Construction”.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

### Uni-Prediction Candidate List Construction

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 15. In case a corresponding LX motion vector of the n-the extended merge candidate does not exist, the L(1−X) motion vector of the same candidate is used instead as the uni-prediction motion vector for geometric partitioning mode

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The two integer blending matrices (W₀ and W₁) are utilized for the GPM blending process. The weights in the GPM blending matrices contain the value range of [0, 8] and are derived based on the displacement from a sample position to the GPM partition boundary 1640 as shown in FIG. 16. Specifically, the weights are given by a discrete ramp function with the displacement and two thresholds, where the two end points (i.e., −τ and τ) of the ramp correspond to lines 1642 and 1644 in FIG. 16.

Here, the threshold T defines the width of the GPM blending area and is selected as the fixed value in VVC. In other words, as JVET-Z0137 (Han Gao, et. al., “Non-EE2: Adaptive Blending for GPM”, Joint Video Experts Team (JVET) of ITU-T SG 16 WP 3 and ISO/IEC JTC 1/SC 29, 26th Meeting, by teleconference, 20-29 Apr. 2022, JVET-Z0137), the blending strength or blending area width θ is fixed for all different contents.

The distance for a position (x,y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 4 )$$

$${ρ}_{j} = {ρ}_{x , j} cos ( {φ}_{i} ) + {ρ}_{y , j} sin ( {φ}_{i} ) \qquad ( 5 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 6 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 7 )$$

where i,j are the indices for angle and offset of a geometric partition, which depend on the signalled geometric partition index. The sign of ρ_{x,j} and ρ_{y,j}, depend on angle index i.

The weights for each part of a geometric partition are derived as following:

$$wIdx ( x , y ) = partIdx ? 32 + d ( x , y ) : 32 - d ( x , y ) \qquad ( 8 )$$

$${w}_{0} ( x , y ) = \frac{Clip 3 ( 0 , 8 , ( wIdx L ( x , y ) + 4 ) ≫ 3 )}{8} \qquad ( 9 )$$

$${w}_{1} ( x , y ) = 1 - {w}_{0} ( x , y ) \qquad ( 10 )$$

The partIdx depends on the angle index i. One example of weigh w₀ is illustrated in FIG. 16, where the angle φᵢ 1610 and offset ρᵢ 1620 are indicated for GPM index i and point 1630 corresponds to the centre of the block. Line 1640 corresponds to the GPM partitioning boundary.

### Motion Field Storage for Geometric Partitioning Mode

Mv1 from the first part of the geometric partition, Mv2 from the second part of the geometric partition and a combined MV of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 11 )$$

where motionIdx is equal to d(4x+2, 4y+2), which is recalculated from equation (7). The partIdx depends on the angle index i.

If sType is equal to 0 or 1, Mv0 or Mv1 are stored in the corresponding motion field, otherwise if sType is equal to 2, a combined MV from Mv0 and Mv2 are stored. The combined My are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.
   Geometric Partitioning Mode (GPM) with Merge Motion Vector Differences (MMVD)

GPM in VVC is extended by applying motion vector refinement on top of the existing GPM uni-directional MVs. A flag is first signalled for a GPM CU, to specify whether this mode is used. If the mode is used, each geometric partition of a GPM CU can further decide whether to signal MVD or not. If MVD is signalled for a geometric partition, after a GPM merge candidate is selected, the motion of the partition is further refined by the signalled MVDs information. All other procedures are kept the same as in GPM.

The MVD is signalled as a pair of distance and direction, similar as in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD). In addition, when pic_fpel_mmvd_enabled_flag is equal to 1, the MVD is left shifted by 2 as in MMVD.

Geometric Partitioning Mode (GPM) with Adaptive Blending

In VVC, the final prediction samples are generated by blending the prediction of the two prediction signals using weighted average. Two integer blending matrices (W₀ and W₁) are used. The weights in the GPM blending matrices are derived from the ramp function based on the displacement from a predicted sample position to the GPM partitioning boundary. The blending area size is fixed to two (i.e., 2 samples on each side of the GPM partition split boundary).

The blending process in ECM is improved by adding four extra blending area sizes (i.e., quarter, half, double, and quadrupole of the existing area size) as shown in FIG. 17. A CU level flag to indicate the selected blending area size is signalled. Furthermore, the extended weighting precision is utilized, in which the maximum value of the weighs is changed from 8 (in VVC) to 32 to accommodate the extended blending area sizes.

Geometric Partitioning Mode (GPM) with Template Matching (TM)

Template matching is applied to GPM. When GPM mode is enabled for a CU, a CU-level flag is signalled to indicate whether TM is applied to both geometric partitions. Motion information for each geometric partition is refined using TM. When TM is chosen, a template is constructed using left, above or left and above neighbouring samples according to partition angle, as shown in Table 1. The motion is then refined by minimizing the difference between the current template and the template in the reference picture using the same search pattern of merge mode with half-pel interpolation filter disabled.

TABLE 1
Template for the 1st and 2nd geometric partitions using above samples
(A), left samples (L), and both left and above samples (L + A).

| Partition | | | | | | | | | | |
|---|---|---|---|---|---|---|---|---|---|---|
| angle | 0 | 2 | 3 | 4 | 5 | 8 | 11 | 12 | 13 | 14 |
| 1^{st} partition | A | A | A | A | L + A | L + A | L + A | L + A | A | A |
| 2^{nd} partition | L + A | L + A | L + A | L | L | L | L | L + A | L + A | L + A |
| Partition | | | | | | | | | | |
| angle | 16 | 18 | 19 | 20 | 21 | 24 | 27 | 28 | 29 | 30 |
| 1^{st} partition | A | A | A | A | L + A | L + A | L + A | L + A | A | A |
| 2^{nd} partition | L + A | L + A | L + A | L | L | L | L | L + A | L + A | L + A |

A GPM candidate list is constructed as follows:
1. Interleaved List-0 MV candidates and List-1 MV candidates are derived directly from the regular merge candidate list, where List-0 MV candidates have higher priority than List-1 MV candidates. A pruning method with an adaptive threshold based on the current CU size is applied to remove redundant MV candidates.
2. Interleaved List-1 MV candidates and List-0 MV candidates are further derived directly from the regular merge candidate list, where List-1 MV candidates have higher priority than List-0 MV candidates. The same pruning method with the adaptive threshold is also applied to remove redundant MV candidates.
3. Zero MV candidates are padded until the GPM candidate list is full.

The GPM-MMVD and GPM-TM are exclusively enabled for one GPM CU. This is done by firstly signalling the GPM-MMVD syntax. When both GPM-MMVD control flags are equal to false (i.e., the GPM-MMVD are disabled for two GPM partitions), the GPM-TM flag is signalled to indicate whether the template matching is applied to the two GPM partitions. Otherwise (at least one GPM-MMVD flag is equal to true), the value of the GPM-TM flag is inferred to be false.

GPM with Inter and Intra Prediction

In JVET-Y0065, in GPM with inter and intra prediction (or named GPM intra), the final prediction samples are generated by weighting inter predicted samples and intra predicted samples for each GPM-separated region. The inter predicted samples are derived by the same scheme as the GPM in the current ECM whereas the intra predicted samples are derived by an intra prediction mode (IPM) candidate list and an index signalled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown FIGS. 18A-C, respectively. Furthermore, GPM with intra and intra prediction as shown FIG. 18D is restricted in the proposed method to reduce the signalling overhead for IPMs and avoid an increase in the size of the intra prediction circuit on the hardware decoder. In addition, a direct motion vector and IPM storage on the GPM-blending area is introduced to further improve the coding performance.

At most two IPM candidates derived from the DIMD method and/or the neighbouring blocks can be registered if there is not the same IPM candidate in the list. As for the neighbouring mode derivation, there are at most five positions for available neighbouring blocks, but they are restricted by the angle of GPM block boundary as shown in Table 2, which are already used for GPM with template matching (GPM-TM).

TABLE 2
The positions of available neighbouring blocks for IPM candidate derivation based on the angle
of GPM block boundary, where A and L denotes the above and left side of the prediction block.

| Partition Angle | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |

| Partition angle | 16 | 18 | 19 | 20 | 21 | 24 | 27 | 28 | 29 | 30 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |

GPM-intra can be combined with GPM with merge with motion vector difference (GPM-MMVD). TIMD is used for IPM candidates of GPM-intra to further improve the coding performance. The Parallel mode can be registered first, then IPM candidates of TIMD, DIMD, and neighbouring blocks.

### Template Matching Based Reordering for GPM Split Modes

In template matching based reordering for GPM split modes, given the motion information of the current GPM block, the respective TM cost values of GPM split modes are computed. Then, all GPM split modes are reordered in ascending order based on the TM cost values. Instead of sending GPM split mode, an index using Golomb-Rice code to indicate where the exact GPM split mode is located in the reordering list is signalled.

The reordering method for GPM split modes is a two-step process performed after the respective reference templates of the two GPM partitions in a coding unit are generated, as follows:
extending GPM partition edge into the reference templates of the two GPM partitions, resulting in 64 reference templates and computing the respective TM cost for each of the 64 reference templates;
reordering GPM split modes based on their TM cost values in ascending order and marking the best 32 split modes as available split modes.

The edge on the template is extended from that of the current CU, as shown in FIG. 19, but GPM blending process is not used in the template area across the edge. After ascending reordering using TM cost, an index is signalled.

### Bi-Predictive GPM

The GPM design in VVC relies on uni-predictive motion vectors to generate motion compensated prediction samples for each inter GPM partition. In ECM, such a design has been extended to allow usage of bi-predictive motion vectors.

When constructing a GPM candidate list, the extraction process that extracts uni-predictive motion vectors from the initial merge list is invoked only for small blocks including 8×8, 16×8 and 8×16. For larger blocks, the extraction process is bypassed, so the initial merge list (which may contain merged Bi-MVs) is directly used as the final GPM merge list. The generation of the initial merge list is the same as before (i.e., the normal merge list generation without any candidate reordering) except that when generating the initial merge list for larger blocks (i.e., blocks with the extraction process bypassed), the motion vector difference threshold for controlling whether a candidate can be added into the list is increased to be one full sample distance.

BDOF based motion vector refinement as in the multi-pass DMVR is used when generating motion compensated prediction samples.

When GPM-MMVD is used for a GPM partition and its base motion vector is bi-predictive, for low-delay pictures, the signalled MVD is applied on top of the L0 and L1 motion vector as in the existing merge MMVD design. For non-low-delay pictures, the bi-predictive motion vector is converted into a uni-predictive motion vector first and then the MVD is applied.

In the present invention, methods and apparatus to extend the prediction for GPM partition to include subblock-based coding tools such as SbTMVP and affine modes are disclosed. Also, the use of inherited LIC (Local Illumination Compensation) for GPM is disclosed.

### BRIEF SUMMARY OF THE INVENTION

A method and apparatus for video coding are disclosed. According to the method, receiving input data associated with a current block, wherein the input data comprise pixel data to be encoded at an encoder side or coded data associated with the current block to be decoded at a decoder side. The current block is partitioned into a first region and a second region along a partition line. A target candidate list comprising one or more GPM (Geometry Partition Mode) subblock candidates corresponding to one or more GPM subblock modes for one of the first region and the second region is derived. Said one of the first region and the second region are encoded or decoded using the target candidate list comprising said one or more GPM subblock candidates.

In one embodiment, said one or more GPM subblock candidates belong to a group comprising one or more SbTMVP (Subblock Temporal Motion Vector Predictor) candidates, one or more affine candidates, one or more DMVR (Decoder Side Motion Vector Refinement)/BDMVR (Bi-Prediction DMVR) candidates, or a combination thereof. In one embodiment, said one or more SbTMVP candidates are inserted after or interleaved with said one or more affine candidates in the target candidate list. In one embodiment, only N SbTMVP candidates with smallest TM (Template Matching) costs are kept, wherein N is a positive integer.

In one embodiment, sample-based affine motion compensation, affine DMVR, affine or SbTMVP BDOF (Bi-Directional Optical Flow) is used to generate one or more affine predictors of said one of the first region and the second region. In one embodiment, if one or more affine parameters associated with a target affine candidate are larger or smaller than a threshold, the target affine candidate is not inserted into the target candidate list.

In one embodiment, a merge mode motion vector difference selected from a pre-defined motion vector difference set is signalled for said one or more SbTMVP candidates or said one or more affine candidates. In one embodiment, one or more motion shifts associated with said one or more SbTMVP candidates or one or more CPMVs associated with said one or more affine candidates are refined according to the merge mode motion vector difference.

In one embodiment, TM (Template Matching) costs associated with a pre-defined motion vector difference set are applied to said one or more SbTMVP candidates or said one or more affine candidates. In one embodiment, one or more motion shifts associated with said one or more SbTMVP candidates or one or more CPMVs associated with said one or more affine candidates are refined according to the TM costs associated with the pre-defined motion vector difference set.

In one embodiment, a GPM subblock flag is signalled or parsed for each of the first region and the second region to indicate whether said one or more GPM subblock modes are used for said each of the first region and the second region. In one embodiment, only one GPM subblock flag is signalled or parsed for both of the first region and the second region to indicate whether said one or more GPM subblock modes are used for both of the first region and the second region. In one embodiment, an index flag is signalled or parsed for each of the first region and the second region to indicate a candidate index selected for said each of the first region and the second region, wherein the index candidate is coded using different arithmetic context models depending on whether said one or more GPM subblock modes are applied to said each of the first region and the second region.

In one embodiment, another of the first region and the second region is encoded or decoded using said one or more GPM subblock modes, one or more inter modes, one or more intra modes, or one or more IBC modes. In one embodiment, only one GPM subblock flag is signalled or parsed for both of the first region and the second region to indicate whether said one or more GPM subblock modes are used for the first region and the second region, wherein when said only one GPM subblock flag is true, at least one of the first region and the second region is coded using said one or more GPM subblock modes. In one embodiment, a partition region is coded by said one or more GPM subblock modes is determined based on TM (Template Matching) or BM (Template Matching) costs associated with using said one or more GPM subblock modes, said one or more inter modes, said one or more intra modes or said one or more IBC modes and one or more target modes with smallest TM or BM costs are selected for the partition region. In one embodiment, an IBC candidate list is constructed or said one or more IBC modes are inserted into a candidate list for a subblock merge mode or an original GPM merge mode.

Another method of using GPM is disclosed. According to this method, receiving input data associated with a current block, wherein the input data comprise pixel data to be encoded at an encoder side or coded data associated with the current block to be decoded at a decoder side. The current block is partitioned into a first region and a second region along a partition line. An inherited LIC (Local Illumination Compensation) flag is determined by inheriting a reference LIC flag associated with a reference block of the current block. The first region and the second region are encoded or decoded using coding information comprising the inherited LIC flag and a candidate list including one or more GPM merge candidates.

In one embodiment, when the inherited LIC flag is applied to the current block, whether to apply LIC process to the current block depends on the inherited LIC flag. In one embodiment, whether the inherited LIC flag for one GPM merge candidate is used by the current block depends on TM (Template Matching) cost calculated for said one GPM merge candidate. In one embodiment, if mean-removed TM cost is smaller than original TM cost, the inherited LIC flag is set to enable for said one GPM merge candidate.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2A illustrates an example of the affine motion field of a block described by motion information of two control point (4-parameter).

FIG. 2B illustrates an example of the affine motion field of a block described by motion information of three control point motion vectors (6-parameter).

FIG. 3 illustrates an example of block based affine transform prediction, where the motion vector of each 4×4 luma subblock is derived from the control-point MVs.

FIG. 4 illustrates the neighbouring blocks used for deriving spatial merge candidates for VVC.

FIG. 5 illustrates an example of derivation for inherited affine candidates based on control-point MVs of a neighbouring block.

FIG. 6 illustrates an example of affine candidate construction by combining the translational motion information of each control point from spatial neighbours and temporal.

FIG. 7 illustrates an example of affine motion information storage for motion information inheritance.

FIG. 8 illustrates an example of sub-block based affine motion compensation, where the motion vectors for individual pixels of a sub-block are derived according to motion vector refinement.

FIG. 9 illustrates an example of Template Matching based OBMC where, for each top block with a size of 4×4 at the top CU boundary, the above template size equals to 4×1.

FIG. 10 illustrate an example of first history-parameter table (HPT) (FIG. 10A) and second history-parameter table (HPT) (FIG. 10B).

FIGS. 11A-B illustrate examples of non-adjacent spatial neighbours for deriving affine merge mode (NSAM), where the pattern of obtaining non-adjacent spatial neighbours is shown in FIG. 11A for deriving inherited affine merge candidates and in FIG. 11B for deriving constructed affine merge candidates.

FIG. 12 illustrates an example of constructed affine candidates according to non-adjacent neighbours, where the motion information of the three non-adjacent neighbours at locations A, B and C is used to form the CPMVs.

FIG. 13 illustrates the neighbouring 4×4 subblocks that are used for RMVF parameter derivation, where W and H are the width and height of the current CU.

FIG. 14 illustrates an example of the of 64 partitions used in the VVC standard, where the partitions are grouped according to their angles and dashed lines indicate redundant partitions.

FIG. 15 illustrates an example of uni-prediction MV selection for the geometric partitioning mode.

FIG. 16 illustrates an example of bending weight coo using the geometric partitioning mode.

FIG. 17 illustrates the ramp function for the weights for GPM blending based on the displacement (d) from a predicted sample position to the GPM partitioning boundary and the blending area size (τ).

FIGS. 18A-C illustrate examples of available IPM candidates: the parallel angular mode against the GPM block boundary (Parallel mode, FIG. 18A), the perpendicular angular mode against the GPM block boundary (Perpendicular mode, FIG. 18B), and the Planar mode (FIG. 18C), respectively.

FIG. 18D illustrates an example of GPM with intra and intra prediction, where intra prediction is restricted to reduce the signalling overhead for IPMs and hardware decoder cost.

FIG. 19 illustrates an example of extending the edge on the template from edge on the current CU for GPM split mode.

FIG. 20 illustrates an example of template usage for GPM LIC.

FIG. 21 illustrates a flowchart of an exemplary video coding system that uses a target candidate list comprising one or more GPM (Geometry Partition Mode) subblock candidates corresponding to one or more GPM subblock modes for one of the first region and the second region according to an embodiment of the present invention.

FIG. 22 illustrates a flowchart of an exemplary video coding system that uses an inherited LIC (Local Illumination Compensation) flag from a reference block according to an embodiment of the present invention

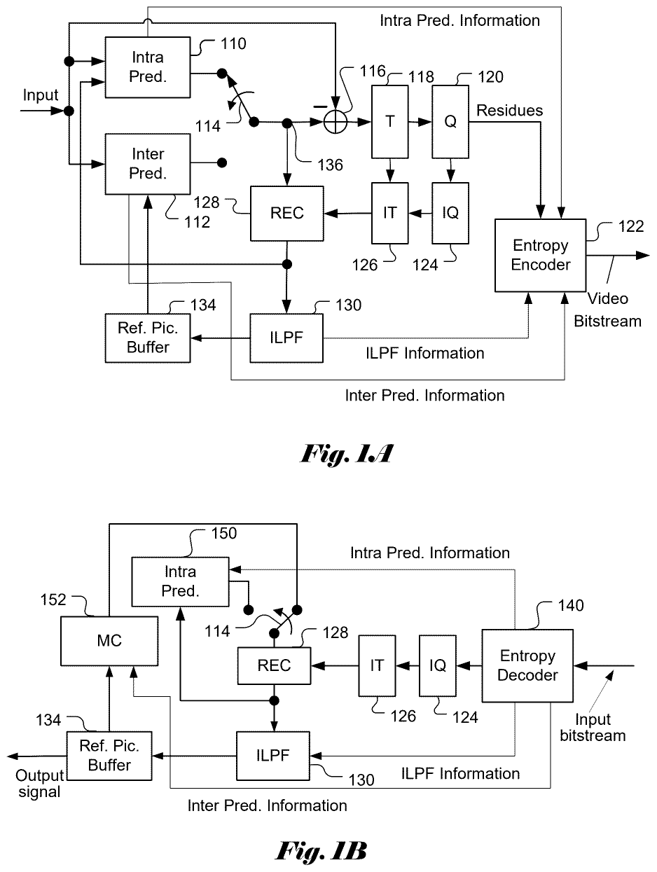

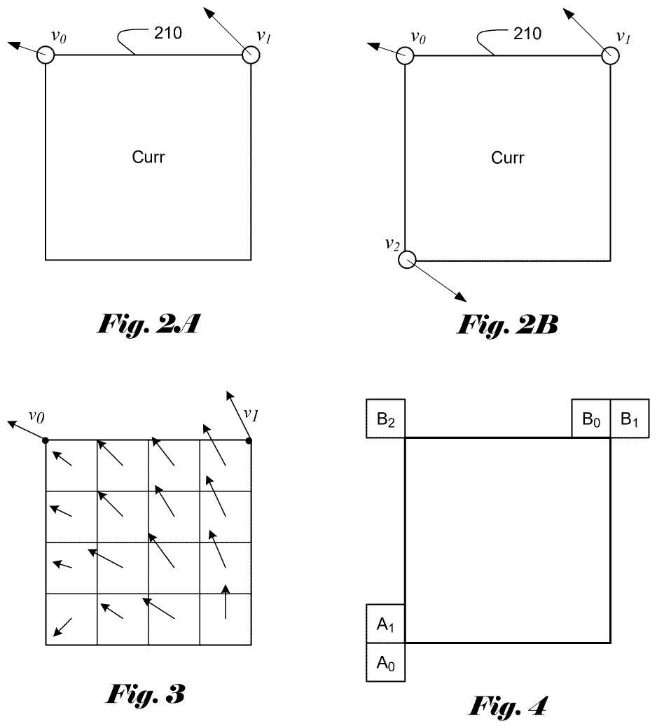

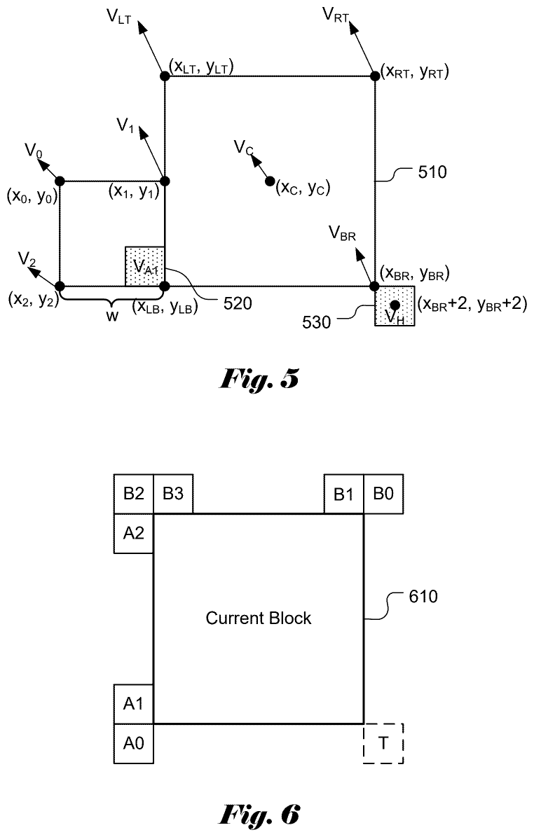

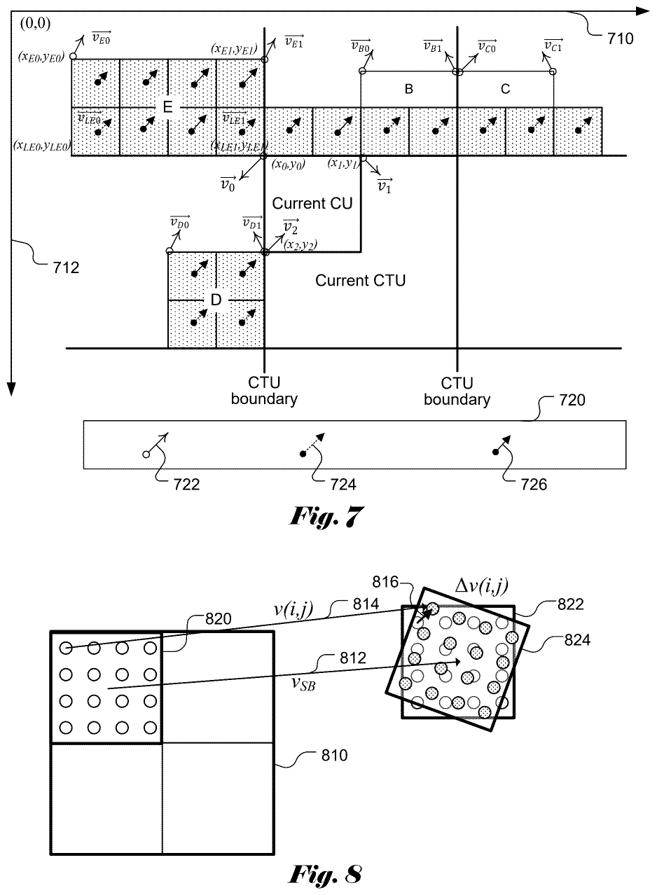

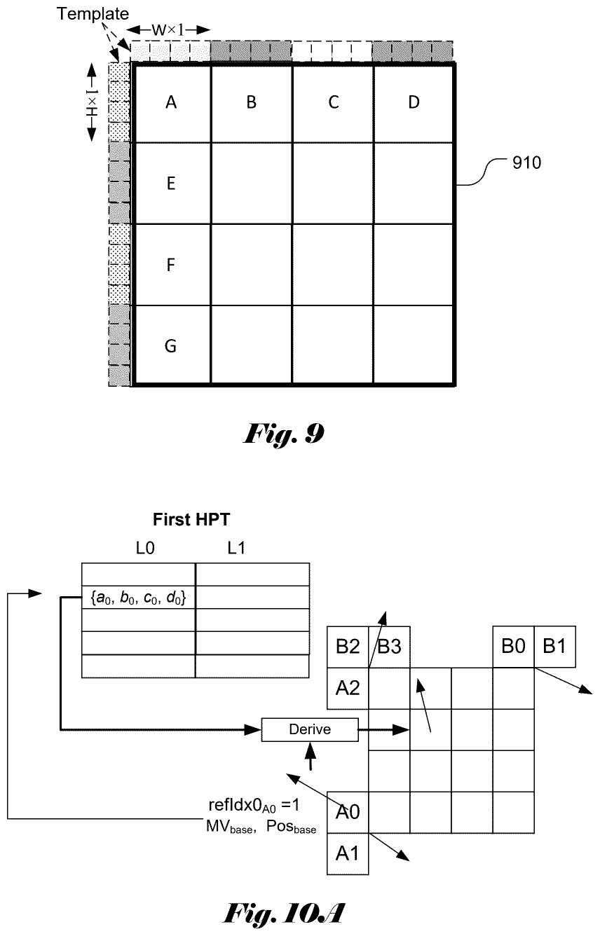

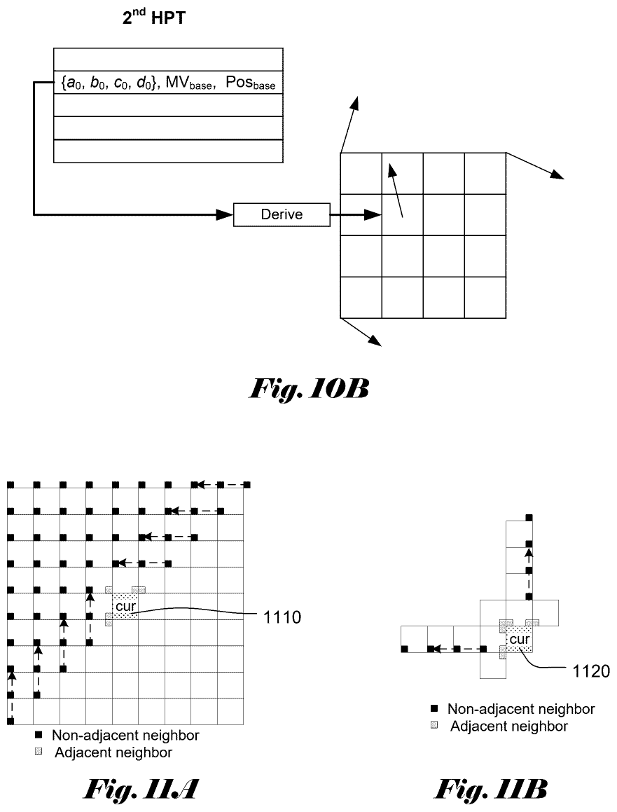

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the current ECM, a GPM predictor is constructed from two reference predictors, a partition mode and a blending width candidate. The reference predictor can be predicted by inter prediction (i.e., MMVD, TM, or bi-predictive inter mode) or intra prediction (i.e., parallel mode, TIMD, DIMD, or MPM). However, the subblock modes (i.e., affine, SbTMVP) are not used to predict the reference predictor for GPM. To predict the rotating or zooming patterns more accurately, we propose several methods to support subblock modes for GPM.

### Separated Subblock Merge Candidate List for GPM

In one invention, the candidates from subblock merge candidate list including SbTMVP, affine candidates, DMVR/BDMVR candidates, any other subblock mode candidates (e.g., the current block being divided into multiple subblocks and each subblock can have different MV), or any combination thereof can be referenced by a GPM-coded CU and used to construct GPM predictors. A GPM partition predicted by subblock merge mode can be combined with the other GPM partition predicted by subblock merge, inter, intra or IBC modes. A gpm_sbm_flag is signalled for each partition to indicate the usage of subblock merge mode for such partition. The merge candidate index for the GPM partition is signalled using different arithmetic context models depending on whether the subblock merge modes or non-subblock-merge mode is applied.

In one embodiment, the SbTMVP candidates are inserted after the affine candidates or interleaved with affine candidates in the subblock merge candidate list for GPM.

In one embodiment, only uni-predictive subblock merge candidates are kept in the subblock merge candidate list for GPM. In another embodiment, for low-delay frames, the uni-predictive and bi-predictive subblock merge candidates can be kept in the candidate list, but for non-low-delay frames, only uni-predictive subblock merge candidates are kept. In another embodiment, for a bi-predictive subblock merge candidate, the L0 MV/CPMVs and L1 MV/CPMVs can be separated into two uni-predictive candidates. Or the TM costs or BM costs of the bi-predictive and uni-predictive candidates are then calculated and used to determine the inter direction (i.e., uni-prediction or bi-prediction) of such subblock merge candidate before inserting into subblock merge candidate list for GPM. In another embodiment, the bi-predicted candidates can be supported in subblock GPM. Similar to uni-prediction GPM, blending the predictors of two partitions is applied, however, the predictors of one partition (or both partition) can be bi-predicted predictors.

In one embodiment, two partitions of the GPM can use different kind of candidates. For example, one from non-subblock candidate, and the other one from subblock candidate.

In one embodiment, only the 4-parameter or/and 6-parameter affine candidates are kept in the subblock merge candidate list for GPM. In another embodiment, only the spatial, non-adjacent, constructed, regression-based, history-based affine candidates, or a combination thereof are kept in the subblock merge candidate list. In another embodiment, only the spatial affine candidates with the same size as current CU are kept. In another embodiment, only N SbTMVP candidates with the smallest TM costs are kept in the candidate list.

In one embodiment, instead of signalling a flag for each partition, only a gpm_sbm_flag is signalled for a GPM-coded CU to indicate whether both partitions are predicted by subblock merge modes. In another embodiment, a flag is first signalled to indicate whether partition 0 is coded by subblock merge modes. If the flag is true, the partition 0 is coded by subblock merge modes and the second flag is not signalled. If the flag is false, the partition 0 is not coded by subblock merge modes and the second flag is signalled to indicate whether partition 1 is coded by subblock merge modes.

In one embodiment, instead of signalling a flag for each partition, only one gpm_sbm_flag is signalled for a GPM-coded CU to indicate whether the subblock merge mode is used or not. If the flag is true, one or two of the GPM partitions are coded by subblock merge mode. If the flag is false, both GPM partitions are not coded by subblock merge mode. To determine whether a GPM partition is coded by subblock merge mode, RD, TM or BM costs are used. If the RD cost is used, the RD costs of all GPM predictors with one partition predicted by subblock merge mode and another partition predicted by inter merge, intra or IBC candidates are calculated and another gpm_sbm_part_flag is signalled to indicate which partition is coded by subblock merge mode. If the TM or BM cost is used, the TM or BM costs of the subblock merge candidates and inter merge, intra or IBC candidates are calculated for both partitions according to the partition mode, and each GPM partition is coded by the candidate with smallest TM or BM cost at that partition. If the gpm_sbm_flag is true, it is guaranteed that at least one of the partitions has a subblock merge candidate with the smallest TM or BM cost. In another example, the TM or BM costs of subblock merge and inter merge, intra or IBC candidates are calculated for each GPM partition, and the GPM partition is determined to be coded by subblock merge mode when the subblock merge candidate with smallest TM or BM cost is smaller than the inter merge, intra or IBC candidate with smallest TM or BM cost in such partition. If the gpm_sbm_flag is true, it is guaranteed that at least one of the partitions that the subblock merge candidate with smallest TM or BM cost is smaller than the inter merge, intra or IBC candidate with smallest TM or BM cost in such partition. In this embodiment, the merge candidate index for the GPM partition, blending width index and partition mode index are signalled using different arithmetic context models depending on gpm_sbm_flag.

In one embodiment, the syntax of subblock merge mode for GPM is signalled after subblock merge flag instead of after geo flag. That is, the flags indicated the usage of subblock merge modes for GPM, GPM partition mode index, GPM blending width index and two GPM merge indices are all signalled after subblock merge flag if the subblock merge modes are used for GPM.

### Joint Inter, Intra, IBC and Subblock Merge Candidate List for GPM

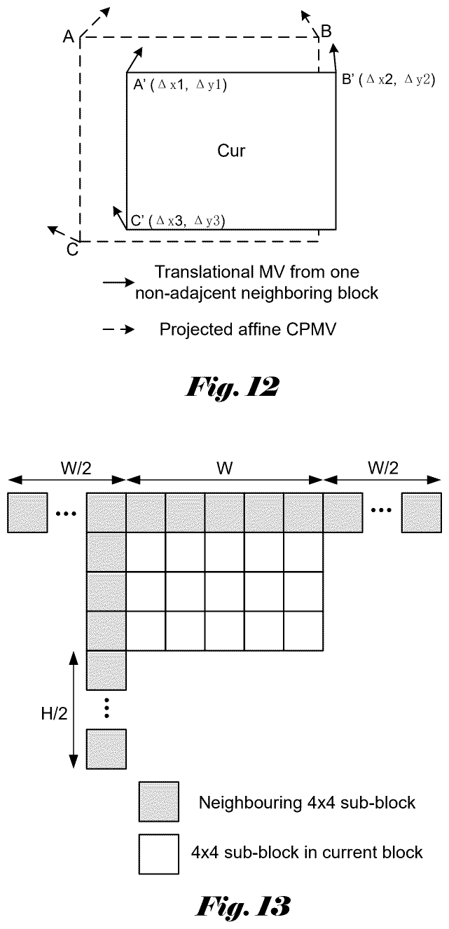

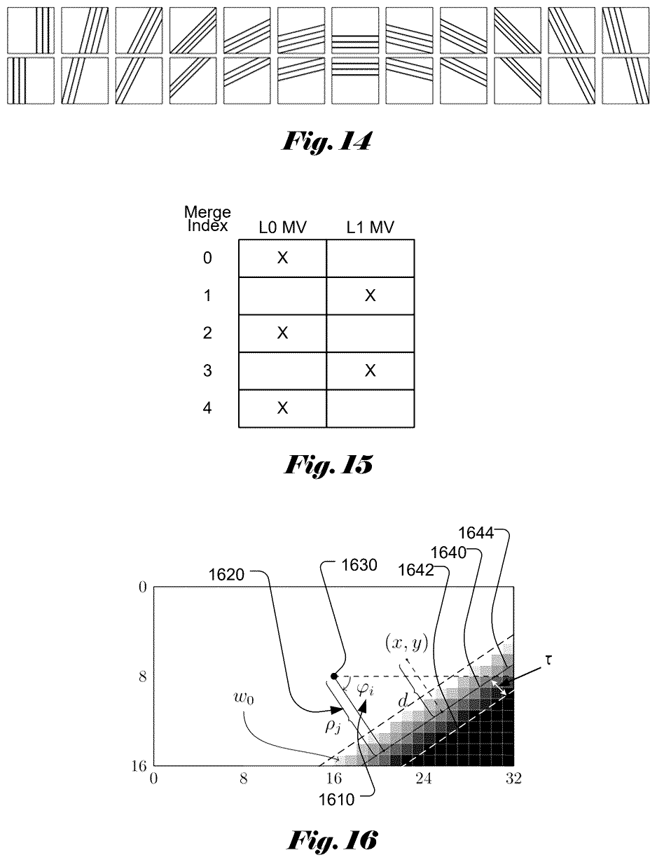

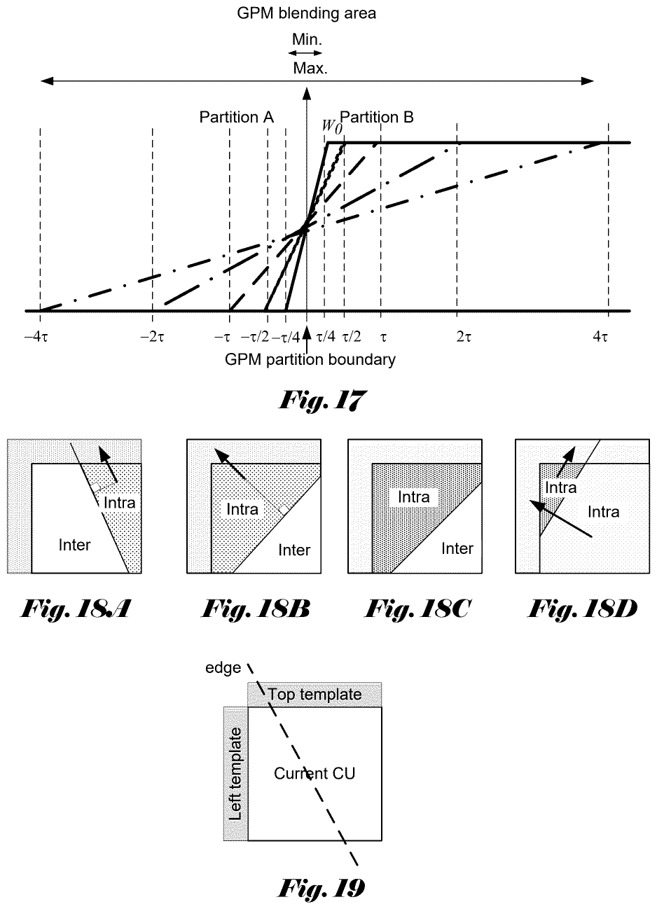

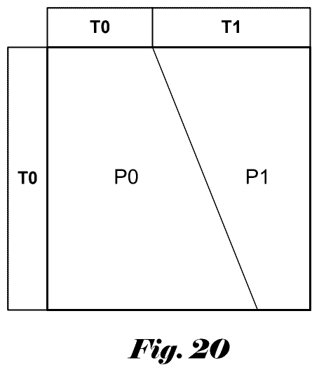

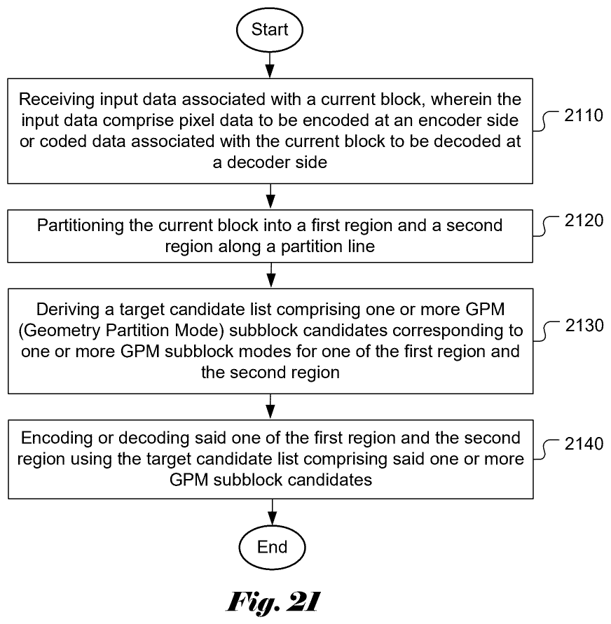

In one invention, a joint inter and subblock merge candidate list is constructed for GPM. If a spatial candidate is coded by subblock merge mode, the candidate is inserted into the joint list to replace the original inter spatial candidate. If a non-adjacent candidate is coded by affine mode, the regression-based affine candidates (as described in Section “Regression-Based Affine Candidates”.) are derived from the candidate and inserted into the joint list. If the three (or two) PUs of three (or two) CPMVs (i.e., A, B, C in FIG. 12.) of a non-adjacent affine candidates are all coded by affine, the non-adjacent affine candidate is derived and inserted into the joint list. If K (K>=1) spatial candidates are coded by affine, history-based affine candidates are inserted into the joint list. If the TMVP candidate doesn't exist, SbTMVP candidates are inserted into the joint list. The GPM partition predicted from the candidate in joint inter and subblock merge candidate list can be combined with the partition predicted from the candidate in joint list, in intra prediction mode (IPM) list or in IBC list.

In another invention, a joint intra and subblock merge candidate list is constructed for GPM. The GPM partition predicted from the candidate in joint intra and subblock merge candidate list can be combined with the partition predicted from the candidate in joint list, in inter merge candidate list or in IBC list.

In another invention, a joint IBC and subblock merge candidate list is constructed for GPM. The GPM partition predicted from the candidate in joint IBC and subblock merge candidate list can be combined with the partition predicted from the candidate in joint list, in inter merge candidate list or in intra prediction mode (IPM) list.

In another embodiment, the subblock merge candidates (including SbTMVP, and/or affine candidates, and/or DMVR/BDMVR candidates, and/or any other subblock mode candidates) are interleaved with inter merge (or intra or IBC) candidates in the joint list instead of replacing the original inter merge (or intra or IBC) candidates.

After the construction of joint candidate list, candidate reordering can be performed by using TM cost and only K1 (K1>=1) candidates with smallest TM costs are kept in the joint list.

Motion Information of GPM with Subblock Merge Modes

In one invention, the motion information of a CU coded by GPM with subblock merge modes is defined. In one embodiment, for a GPM partition predicted by subblock merge mode, the motion of each 4×4 subblock in the partition is calculated from the affine model of the selected subblock merge candidate or referenced from the collocated block pointed by the selected SbTMVP motion shift. For the other GPM partition, if the partition is also predicted by subblock merge mode, the motion of each 4×4 subblock in such partition is calculated from the affine model of another selected subblock merge candidate or referenced from the collocated block pointed by another selected SbTMVP motion shift. If the partition is predicted by inter merge mode, the motion of each 4×4 subblock is assigned as the MV of the selected inter merge candidate. If the partition is predicted by intra or IBC mode and the other partition is predicted by subblock merge mode, the motion of each 4×4 subblock in the partition is calculated from the affine model of the subblock merge candidate in the other GPM partition or referenced from the collocated block pointed by the selected SbTMVP motion shift in the other GPM partition.

In another embodiment, for a GPM partition predicted by subblock merge mode and the other partition predicted by inter merge mode, the motion of each 4×4 subblock in the partition is assigned as the MV of the inter merge candidate in the other partition. For a GPM partition predicted by subblock merge mode and the other partition predicted by intra or IBC mode, the motion of each 4×4 subblock in the partition is calculated from the affine model of the selected subblock merge candidate or referenced from the collocated block pointed by the selected SbTMVP motion shift.

In one embodiment, for each 4×4 subblock in the GPM blending region, the motion is blended by the MVs from two GPM partitions. In one example, if both partitions are predicted by uni-predictive candidates, the motion of each 4×4 subblock in blending region is assigned as the combination of two MVs from two uni-predictive candidates from two GPM partitions. That is, one MV is assigned as the L0 MV and the other MV is assigned as L1 MV. If one of the partitions is predicted by a L0 uni-predictive inter or subblock merge candidate, the L0 motion of each 4×4 subblock in the blending region is assigned as the MV derived from the selected inter or subblock merge candidates (i.e., for subblock merge candidate, each 4×4 subblock L0 MV is calculated from the affine model of another selected subblock merge candidate or referenced from the collocated block pointed by another selected SbTMVP motion shift. For inter merge candidate, each 4×4 subblock L0 MV is assigned as the MV of the selected inter merge candidate). If one of the partitions is predicted by a L1 uni-predictive inter or subblock merge candidate, the Li motion of each 4×4 subblock in the blending region is assigned as the MV derived from the selected inter or subblock merge candidates. If a GPM partition is predicted by L0 uni-predictive candidate and the other GPM partition is predicted by Li uni-predictive candidate, the L0 and L1 MV of each 4×4 subblock in blending region are derived from the corresponding L0 and Li candidates. If both partitions are predicted by L0 uni-predictive candidates or both partitions are predicted by Li uni-predictive candidates, one of the L0/L1 uni-predictive candidates are used to derive the L1/L0 MV (i.e., the MV in opposite reference list) of each 4×4 subblock. The candidate used to derive the MV in opposite reference list is determined by the coding mode, MV magnitude, TM/BM cost, QP or POC distance. In one example, if both partitions are predicted by L0 uni-predictive candidates, the candidate with smaller POC distance is used to derive L0 motion of each 4×4 subblock and the candidate with larger POC distance is used to derive L1 motion of each 4×4 subblock.

In another embodiment, if at least one of the partitions is predicted by bi-prediction, the motion of each 4×4 subblock in the GPM blending region is derived by the bi-predictive candidate. If both partitions are predicted by bi-predictive candidates, the coding mode, MV magnitude, TM/BM cost, QP or POC distance is used to determine which bi-predictive candidate is used to derive the motion of each 4×4 subblock in blending region. In one example, the TM costs of both bi-predictive candidates are calculated and the candidate with smaller TM cost are used to derive the motion of each 4×4 subblock in blending region.

In another embodiment, if both the partitions are predicted by inter or subblock merge candidates, the motion of each 4×4 subblock in the GPM blending region is derived by the candidate with smaller QP, POC distance, TM/BM cost, MV magnitude, or a combination thereof. In another example, the motion of each 4×4 subblock in the GPM blending region is derived by the candidate with larger MV magnitude. In another example, the motion of each 4×4 subblock in the GPM blending region is derived by the candidate with subblock merge mode or inter merge mode.

### Extensions of Subblock Merge Modes for GPM

In one invention, an MV difference (MVD) selected from a predefined candidate set can be applied to affine or SbTMVP candidates. For affine candidates, the MVD is applied to one, two or three CPMVs respectively. For SbTMVP candidates, the MVD is applied to the motion shift on collocated frame. In one example, the MVD candidate is selected from {¼-pel, ½-pel, 1-pel, 2-pel, 3-pel, 4-pel, 6-pel, 8-pel, 16-pel} in one of four horizontal/vertical directions or one of four diagonal directions or {¼-pel, ½-pel, 1-pel, 2-pel, 4-pel, 8-pel, 16-pel, 32-pel} in one of four horizontal/vertical directions. In another example, the MVD candidate is selected from {¼-pel, ½-pel, 1-pel, 2-pel, 3-pel, 4-pel, 6-pel, 8-pel, 16-pel, 32-pel} in one of the directions parallel to the partition modes.

In one embodiment, to reduce the MVD candidate set, the SAD-based costs or mean-removed SAD-based costs between the templates of MVD candidates and the current template are calculated and used to determine the final MVD candidate. Specifically, only N MVD candidates with smallest costs remain and the final MVD candidate is selected from the remaining candidate set according to RD costs.

In one invention, the GPM partition predicted by subblock merge candidates can be refined according to TM costs. An MV offset selected from a predefined candidate set is applied to one, two or three CPMVs respectively for an affine candidate. For SbTMVP candidates, the MV offset is applied to the motion shift on collocated frame. In one example, the MV offset candidate is selected from {¼-pel, ½-pel, 1-pel, 2-pel, 3-pel, 4-pel} and used to perform first round diamond or cross search. After the first round search, if the minimum TM cost is smaller than the initial TM cost*C (C<1), second round search is then performed. The iteration number can be any number larger than 1. The magnitude of the MV offset can be smaller or not as the iteration round increases.

In one invention, LIC (Local Illumination Compensation) is enabled for GPM and the template samples used to derive the linear model of each GPM partition are determined by the partition mode. Specifically, the linear model of a GPM merge candidate (i.e., subblock merge candidate, inter merge candidate, intra prediction mode candidate or IBC candidate) may be derived by not using the entire top and left template samples, instead only using the template samples adjacent to the GPM partition as shown in FIG. 20. For GPM partition 0 (P0), only template samples in T0 region are used to derive linear model. For GPM partition 1 (P1), only template samples in T1 region are used to derive linear model.

In another embodiment, the LIC linear model of a GPM merge candidate is derived from the entire top and left templates.

In another embodiment, the LIC flag of a GPM-coded CU is inherited from the reference GPM merge candidate. In another embodiment, the LIC usage of each GPM merge candidate is determined by the TM costs. That is, if the mean-removed TM cost is smaller than the original TM cost, LIC is enabled for the GPM merge candidate. To favour the inherited LIC flag, a factor F (F<1) is multiplied with the TM cost when the inherited LIC flag is false. Otherwise, when the inherited LIC flag is true, the factor F is multiplied with the mean-removed TM cost.

In one embodiment, the sample-based affine motion compensation (MC) is used to generate the affine predictors of GPM regardless of the condition of OBMC flag. That is, a GPM partition predicted by affine mode can be generated by sample-based affine motion compensation with or without subblock-boundary OBMC.

In another embodiment, a GPM partition predicted by affine mode can be generated by subblock-based affine motion compensation with affine PROF or sample-based affine motion compensation depending on the affine model or OBMC flag. If the subblock MV difference between two affine subblocks is larger than a threshold or the OBMC flag is false, the sample-based affine MC is used. Otherwise, the subblock-based affine MC with PROF is used.

In one invention, the affine DMVR can be enabled for the GPM partition predicted by affine. That is, if a bi-predictive affine merge candidate meets the DMVR condition, the candidate can be refined by affine DMVR. When affine DMVR is applied, the subblock BM refinement and/or the non-translational parameter refinement are applied. In another embodiment, the affine DMVR is disabled for the GPM. In another embodiment, only the uni-prediction of the refined candidate is used. That is, after or before applying affine DMVR, L0 and L1 MV information of a bi-predictive candidates can be separated into two uni-predictive candidates. The two uni-predictive candidates can be inserted in subblock merge candidate list for GPM respectively.

In one invention, the affine and SbTMVP BDOF can be enabled for the GPM partition predicted by subblock merge mode. That is, if a bi-predictive affine merge candidate meets the BDOF condition, the candidate can be refined by affine or SbTMVP BDOF. When the affine or SbTMVP BDOF is applied, the 8×8 BDOF MV refinement, 4×4 BDOF MV refinement, sample-based BDOF refinement, or a combination thereof is applied. In one example, the PROF is applied interleaving with BDOF refinement. That is, before each stage of BDOF MV refinement and sample-based BDOF refinement, PROF is first applied to refine the predictor. In another embodiment, the affine and SbTMVP BDOF is disabled for the GPM. In another embodiment, only the uni-prediction of the refined candidate is used. That is, after or before applying affine or SbTMVP BDOF, L0 and L1 MV information of a bi-predictive candidate can be separated into two uni-predictive candidates. The two uni-predictive candidates can be inserted into subblock merge candidate list for GPM respectively.

In one invention, the affine model of an affine merge candidate is used to determine the usage the candidate for GPM. Specifically, if one, two, three or four of the affine parameters (i.e., a, b, d, and e) of an affine candidate are larger and/or smaller than a threshold, the affine candidate cannot be inserted into the subblock merge candidate list.

$$\{ \begin{matrix}{v}_{x} = a x + b y + c \\ {v}_{y} = d x + e y + f\end{matrix}$$

Any of the foregoing proposed methods of extending the prediction for GPM partition to include subblock-based coding tools such as SbTMVP and affine modes, or using inherited LIC for GPM can be implemented in encoders and/or decoders. For example, any of the proposed methods can be implemented in an inter/intra/IBC/prediction/transform module of an encoder, and/or an inter/intra/IBC/prediction/transform module of a decoder. Alternatively, any of the proposed methods can be implemented as a circuit coupled to the inter/intra/IBC/prediction/transform module of the encoder and/or the inter/intra/IBC/prediction/transform module of the decoder, so as to provide the information needed by the inter/intra/IBC/prediction/transform module.

FIG. 21 illustrates a flowchart of an exemplary video coding system that uses a target candidate list comprising one or more GPM (Geometry Partition Mode) subblock candidates corresponding to one or more GPM subblock modes for one of the first region and the second region according to an embodiment of the present invention. The steps shown in the flowchart may also be implemented based hardware such as one or more electronic devices or processors arranged to perform the steps in the flowchart. According to the method, receiving input data associated with a current block in step 2110, wherein the input data comprise pixel data to be encoded at an encoder side or coded data associated with the current block to be decoded at a decoder side. The current block is partitioned into a first region and a second region along a partition line in step 2120. A target candidate list comprising one or more GPM (Geometry Partition Mode) subblock candidates corresponding to one or more GPM subblock modes for one of the first region and the second region is derived in step 2130. Said one of the first region and the second region are encoded or decoded using the target candidate list comprising said one or more GPM subblock candidates in step 2140.

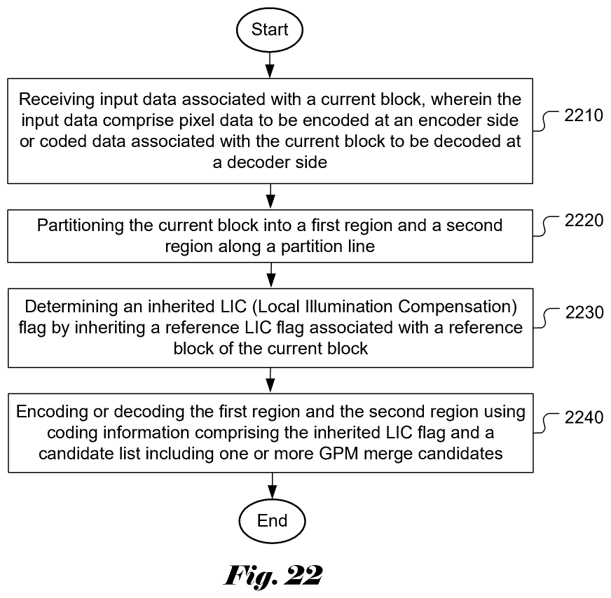

FIG. 22 illustrates a flowchart of an exemplary video coding system that uses an inherited LIC (Local Illumination Compensation) flag from a reference block according to an embodiment of the present invention. According to the method, receiving input data associated with a current block in step 2210, wherein the input data comprise pixel data to be encoded at an encoder side or coded data associated with the current block to be decoded at a decoder side. The current block is partitioned into a first region and a second region along a partition line in step 2220. An inherited LIC (Local Illumination Compensation) flag is determined by inheriting a reference LIC flag associated with a reference block of the current block in step 2230. The first region and the second region are encoded or decoded using coding information comprising the inherited LIC flag and a candidate list including one or more GPM merge candidates in step 2240.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data to be encoded at an encoder side or coded data associated with the current block to be decoded at a decoder side;
partitioning the current block into a first region and a second region along a partition line;
deriving a target candidate list comprising one or more GPM (Geometry Partition Mode) subblock candidates corresponding to one or more GPM subblock modes for one of the first region and the second region; and
encoding or decoding said one of the first region and the second region using the target candidate list comprising said one or more GPM subblock candidates.

2. The method of claim 1, wherein said one or more GPM subblock candidates belong to a group comprising one or more SbTMVP (Subblock Temporal Motion Vector Predictor) candidates, one or more affine candidates, one or more DMVR (Decoder Side Motion Vector Refinement)/BDMVR (Bi-Prediction DMVR) candidates, or a combination thereof.

3. The method of claim 2, wherein said one or more SbTMVP candidates are inserted after or interleaved with said one or more affine candidates in the target candidate list.

4. The method of claim 2, wherein only N SbTMVP candidates with smallest TM (Template Matching) costs are kept, wherein N is a positive integer.

5. The method of claim 2, wherein sample-based affine motion compensation, affine DMVR, affine or SbTMVP BDOF (Bi-Directional Optical Flow) is used to generate one or more affine predictors of said one of the first region and the second region.

6. The method of claim 5, wherein if one or more affine parameters associated with a target affine candidate are larger or smaller than a threshold, the target affine candidate is not inserted into the target candidate list.

7. The method of claim 2, wherein a merge mode motion vector difference selected from a pre-defined motion vector difference set is signalled for said one or more SbTMVP candidates or said one or more affine candidates.

8. The method of claim 7, wherein one or more motion shifts associated with said one or more SbTMVP candidates or one or more CPMVs associated with said one or more affine candidates are refined according to the merge mode motion vector difference.

9. The method of claim 2, wherein TM (Template Matching) costs associated with a pre-defined motion vector difference set are applied to said one or more SbTMVP candidates or said one or more affine candidates.

10. The method of claim 9, wherein one or more motion shifts associated with said one or more SbTMVP candidates or one or more CPMVs associated with said one or more affine candidates are refined according to the TM costs associated with the pre-defined motion vector difference set.

11. The method of claim 1, wherein a GPM subblock flag is signalled or parsed for each of the first region and the second region to indicate whether said one or more GPM subblock modes are used for said each of the first region and the second region.

12. The method of claim 1, wherein only one GPM subblock flag is signalled or parsed for both of the first region and the second region to indicate whether said one or more GPM subblock modes are used for both of the first region and the second region.

13. The method of claim 1, wherein an index flag is signalled or parsed for each of the first region and the second region to indicate a candidate index selected for said each of the first region and the second region, wherein the index candidate is coded using different arithmetic context models depending on whether said one or more GPM subblock modes are applied to said each of the first region and the second region.

14. The method of claim 1, wherein another of the first region and the second region is encoded or decoded using said one or more GPM subblock modes, one or more inter modes, one or more intra modes, or one or more IBC modes.

15. The method of claim 14, wherein only one GPM subblock flag is signalled or parsed for both of the first region and the second region to indicate whether said one or more GPM subblock modes are used for the first region and the second region, wherein when said only one GPM subblock flag is true, at least one of the first region and the second region is coded using said one or more GPM subblock modes.

16. The method of claim 14, wherein whether a partition region is coded by said one or more GPM subblock modes is determined based on TM (Template Matching) or BM (Template Matching) costs associated with using said one or more GPM subblock modes, said one or more inter modes, said one or more intra modes or said one or more IBC modes and one or more target modes with smallest TM or BM costs are selected for the partition region.

17. The method of claim 14, wherein an IBC candidate list is constructed or said one or more IBC modes are inserted into a candidate list for a subblock merge mode or an original GPM merge mode.

18. An apparatus for video coding, the apparatus comprising one or more electronics or processors arranged to:
receive input data associated with a current block, wherein the input data comprise pixel data to be encoded at an encoder side or coded data associated with the current block to be decoded at a decoder side;
partition the current block into a first region and a second region along a partition line;
derive a target candidate list comprising one or more GPM (Geometry Partition Mode) subblock candidates corresponding to one or more GPM subblock modes for one of the first region and the second region; and
encode or decode said one of the first region and the second region using the target candidate list comprising said one or more GPM subblock candidates.

19. A method of video coding, the method comprising:
receiving input data associated with a current block, wherein the input data comprise pixel data to be encoded at an encoder side or coded data associated with the current block to be decoded at a decoder side;
partitioning the current block into a first region and a second region along a partition line;
determining an inherited LIC (Local Illumination Compensation) flag by inheriting a reference LIC flag associated with a reference block of the current block;
encoding or decoding the first region and the second region using coding information comprising the inherited LIC flag and a candidate list including one or more GPM merge candidates.

20. The method of claim 19, wherein when the inherited LIC flag is applied to the current block, whether to apply LIC process to the current block depends on the inherited LIC flag.

21. The method of claim 19, wherein whether the inherited LIC flag for one GPM merge candidate is used by the current block depends on TM (Template Matching) cost calculated for said one GPM merge candidate.

22. The method of claim 21, wherein if mean-removed TM cost is smaller than original TM cost, the inherited LIC flag is set to enable for said one GPM merge candidate.

23. An apparatus for video coding, the apparatus comprising one or more electronics or processors arranged to:
receive input data associated with a current block, wherein the input data comprise pixel data to be encoded at an encoder side or coded data associated with the current block to be decoded at a decoder side;
partition the current block into a first region and a second region along a partition line;
determine an inherited LIC (Local Illumination Compensation) flag by inheriting a reference LIC flag associated with a reference block of the current block;
encode or decode the first region and the second region using coding information comprising the inherited LIC flag and a candidate list including one or more GPM merge candidates.
